(19) United States
(12) Patent Application Publication
(10) Pub. No.: US 2002/0172358 A1
(43) Pub. Date: Nov. 21, 2002

(54) Method and device for data encryption in programming of control units

(76) Inventor: Martin Hurich, Ihrlerstein (DE)

Correspondence Address: KENYON & KENYON, ONE BROADWAY, NEW YORK, NY, 10004, US

(21) Appl. No.: 10/090,718

(22) Filed: Mar. 4, 2002

(30) Foreign Application Priority Data
Mar. 2, 2001 (DE) 101 10 049.3

(51) Int. Cl. H04K 1/04

(52) U.S. Cl. 380/37

(57) ABSTRACT

A method and a device for data encryption in programming of control units is described. In this method, the data to be transmitted is encrypted byte by byte with a first key in a programming unit and then transmitted to a control unit via a data line. Then the data is decrypted in the control unit by using a second key which is provided in the control unit.

### FIELD OF THE INVENTION

The present invention relates to a method and a device for data encryption in programming of control units.

### BACKGROUND INFORMATION

Electronically stored data is encrypted to prevent it from being intercepted or even altered. Without the proper key for decryption of the data, it cannot be used by an unauthorized party.

In programming a control unit, a data stream is transmitted via a data line from a programming unit to a control unit for programming. Meanwhile, both users and programmers have demanded methods of encrypting the data stream. This is to prevent unauthorized access to the content of the memory modules in the control unit.

It should be pointed out that the encryption method should be suitable for use with other coding methods and compression methods without any loss of efficacy or without causing any mutual impairment of the methods.

A distinction should be made between symmetrical and asymmetrical methods. In the symmetrical methods, one key is used for both encryption and decryption. In asymmetrical methods, the key for encryption differs from the key for decryption.

A symmetrical, block-oriented encryption method in which wandering XOR masks are used for encryption is known. This method is characterized by its simplicity and is therefore especially suitable for use in control units. One disadvantage is that a potential hacker may discover the key from large areas of known data (e.g., filler areas which are usually made up of FFh or 00h). Long chains of the same bits usually occur especially when using compression methods based on Huffmann coding. This makes it easier for the hacker to break the code.

U.S. Pat. No. 5,724,428 describes a method of transmitting data which permits encryption and decryption of the transmitted data. This publication describes the use of a secret key which is also transmitted in encrypted form from the sender to the receiver. This secret key is then used to encrypt and decrypt the data transmitted.

The encryption method per se uses a field of any desired size which is linked to the values to be encrypted. It is important here that the data to be encrypted is first divided into first words and second words. These words may have any desired but fixed lengths. Subsequently an invertible operation is applied to these words. First, the first words are linked to the first element of the field described above and then the second words are linked to the second element of the field. The words are alternately linked together by the invertible operation and then they are rotated by the number of positions corresponding to the other word. Then the next element of the field described above is added to these words.

Since the data to be encrypted is divided into first words and second words, this method may not be applied to individual bytes. The fact that the key is also be transmitted each time has proven to be complicated as well as risky.

### SUMMARY OF THE INVENTION

The present invention provides an alternative method and a device for data encryption in programming of control units.

According to the method of the present invention, the data to be transmitted is first encrypted with a first key in a programming unit, the encrypted data is transmitted via a data line to a control unit and the data is decrypted in the control unit using a second key which is provided in the control unit.

Due to the fact that the key is not being transmitted with the data but instead is already provided in the control unit, data volume to be transmitted is reduced and security is increased.

The device according to the present invention for data encryption in programming of control units has a programming unit in which a first key is provided, a control unit in which a second key is provided, and a data line for transmission of the encrypted data.

In the method according to the present invention, either a symmetrical encryption method or an asymmetrical encryption method may be used. If the first key and the second key are identical, it is a symmetrical encryption method. If the first key and the second key are not identical, it is an asymmetrical encryption method.

A table S having m elements S₀ through Sₘ₋₁ can be used for the encryption. This table is accessed by using a hash function h(x), where h(x) is an index.

An encrypted byte n* is formed from an unencrypted byte n according to the following procedure (a starting value n₋₁ is used for encryption and decryption):

n₋₁≡S₀ (formula 1)

$${n}_{i}^{*} = ( {n}_{i} \text{<<<} {\sum }_{j = 0}^{i} {n}_{j - 1}^{*} ) ⊕ {S}_{h ( {\sum }_{j = 0}^{i} {n}_{j - 1}^{*} )} \qquad \text{(formula 2)}$$

Unencrypted byte n is formed from an encrypted byte n* according to the following procedure:

$${n}_{i} = ( {n}_{i}^{*} ⊕ {S}_{h ( {\sum }_{j = 0}^{i} {n}_{j - 1}^{*} )} ) \text{>>>} {\sum }_{j = 0}^{i} {n}_{j - 1}^{*} \qquad \text{(formula 3)}$$

The key may be implemented in the form of an electronic circuit, e.g., in an ASIC or a computer program.

The computer program may be stored on suitable data media such as EEPROMs, flash memories or even CD ROMs, diskettes or hard drives. The computer program is run on an electronic computing unit, e.g., a microprocessor, in the programming unit or control unit.

The programming unit and the control unit may include an electronic computing unit and a memory module linked together by a data bus. For example, a microprocessor may be used as the electronic computing unit.

In the case when the key is transmitted from the sender to the receiver, a table which is accessed by a hash function is also suitable for use as the key.

### BRIEF DESCRIPTION OF THE DRAWINGS

FIG. 1 shows an embodiment of the device according to the present invention in a schematic diagram.

FIG. 2 shows an embodiment of the method according to the present invention in a flow chart.

### DETAILED DESCRIPTION

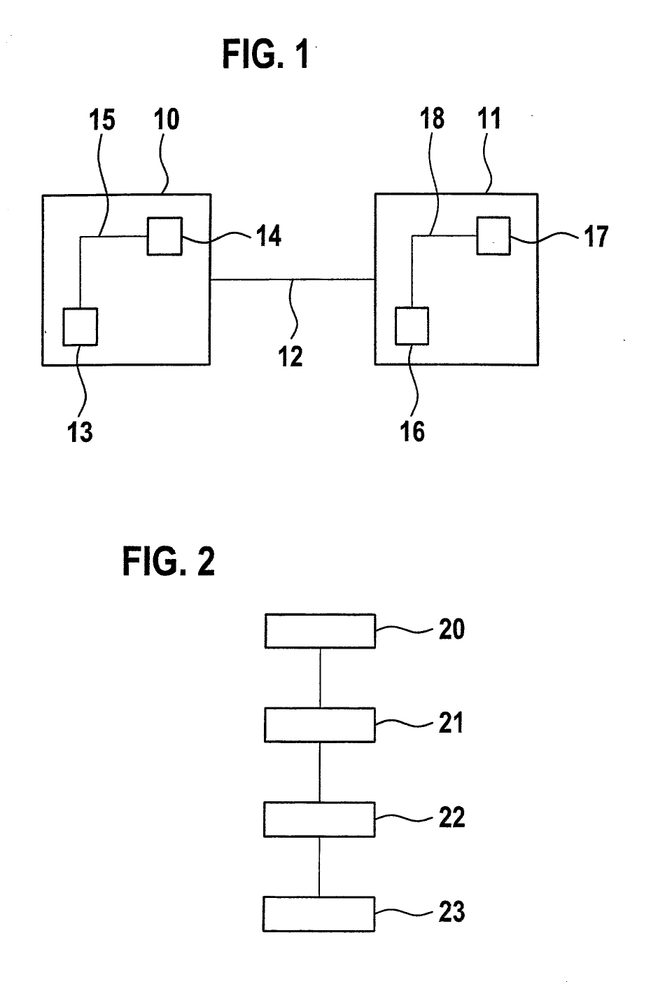

FIG. 1 shows schematically the design of a device according to the present invention, having a programming unit 10, a control unit 11 and a data line 12. In addition, programming unit 10 has a microprocessor 13 and a memory element 14 which are linked together by a data bus 15. A comparable schematic design is also found in control unit 11, which has a microprocessor 16, memory module 17 and a data bus 18.

The mode of operation of the device according to the present invention is explained below:

Data for programming control unit 11 is stored in memory module 14 of programming unit 10. The data is encrypted by microprocessor 13 by using a table and a hash function which are also stored in memory module 14.

This method makes use of the following reversible operations:

rotation to the left (within a byte): <<<

rotation to the right (within a byte): >>>

byte-by-byte exclusive or: ⊕

The results here are invariant with respect to rotation by multiples of 8.

For encryption, a table S having m elements S₀ through Sₘ₋₁ is used. This table is accessed by a hash function h(x), where h(x) is an index.

For a simpler description, the successive bytes during encryption are provided with an index i, where i=0, 1, 2, . . .

An encrypted byte n* is formed from an unencrypted byte n according to the following procedure (a starting value n₋₁ is used for decryption and encryption):

n₋₁≡S₀ (formula 1)

$${n}_{i}^{*} = ( {n}_{i} \text{<<<} {\sum }_{j = 0}^{i} {n}_{j - 1}^{*} ) ⊕ {S}_{h ( {\sum }_{j = 0}^{i} {n}_{j - 1}^{*} )} \qquad \text{(formula 2)}$$

The encrypted data is then transmitted via data line 12 to control unit 11. If the data is intercepted during transmission, it is harmless because the encrypted data cannot be utilized without the key, which is not transmitted along with the data.

The encrypted data is stored in memory module 17 of control unit 11. Memory module 17 contains the same key as that in memory module 14 of programming unit 10. The data is decrypted again with this key.

Unencrypted byte n is formed from an encrypted byte n* according to the following procedure:

$${n}_{i} = ( {n}_{i}^{*} ⊕ {S}_{h ( {\sum }_{j = 0}^{i} {n}_{j - 1}^{*} )} ) \text{>>>} {\sum }_{j = 0}^{i} {n}_{j - 1}^{*} \qquad \text{(formula 3)}$$

Then control unit 11 may be programmed. The decrypted data is processed by microprocessor 16.

The flow chart in FIG. 2 illustrates the sequence of the method according to the present invention.

In step 20, the encryption of the data which is provided for programming the control unit is performed first. The data to be encrypted is not broken down into first and second words, as described in the related art. Therefore, this method may also be used for individual bytes. This method employs a rotation about a number of positions which depends on the entire history of the encryption. The encryption of a byte is thus not predetermined but instead depends on the history.

The elements of the field are not used in linear sequence but instead are selected by a hash function. The linking is not additive, but instead is accomplished by way of an exclusive or operation. An additional parameter is not the number of the operation but instead the selection of the hash function. This greatly reduces operating time.

Data transmission via data line 12 takes place in a subsequent step 21. Since the transmitted data is encrypted, it is of no use for a possible hacker.

Then in step 22 the data is entered, i.e., stored in memory module 17 of control unit 11.

Then in step 23 the data is decrypted. The key for decryption is stored as a computer program in the memory module of control unit 11.

The same key is used for decryption as the key used for encryption. This is thus a symmetrical method.

In comparison with the method described above in which wandering XOR masks are used for encryption, the key is not transmitted in the data stream or together with other parameters but instead is already present in the control unit. In addition, no table is generated from pseudo-random numbers on the basis of such parameters.

In contrast with known methods, there is no addition of key values during the encryption and decryption. In the method according to the present invention, the input values are not distributed among two or more registers and so they can be altered simultaneously thereafter.

The method according to the present invention is characterized in that the key, namely in this case the table and the hash function, are not transmitted over the data line in the data stream but instead are already present in the control unit.

The method described here does not distribute the input values to two or more registers so they can be altered simultaneously thereafter, so it may also be used for individual bytes; this is particularly advantageous within flash programming.

The method according to the present invention is typically used by a plurality of users. Therefore, that inadvertent data exchange between different users is to be prevented. This is avoidable because the method described here is parameterizable.

With this method it is possible to safely encrypt large domains having the same content (filling areas). The encrypted domains do not provide any information regarding the key used. A byte-wise allocation between input and output data is impossible.

This method does not require a temporary memory location for the data stream or parts thereof. Only one byte is needed as the memory location for the running total. The code demand for decryption is very low (approx. 130 bytes). This is extremely important for use in automotive control units.

It is also possible to adapt this method to different requirements by using a user-specific table. In addition, any desired hash function may be used for table access to make possible inferences regarding the content of the table difficult.

The data throughput with the system described here can be as high as 7 MB/minute, for example.

What is claimed is:

1. A method of data encryption in programming of a control unit comprising:
encrypting data to be transmitted in a programming unit using a first key;
transmitting the encrypted data to the control unit via a data line; and
decrypting the encrypted data in the control unit using a second key provided in the control unit.

2. The method of claim 1, wherein the first key and the second key are identical.

3. The method of claim 1, wherein the first key and the second key are not identical.

4. The method of claim 2, wherein each one of the first key and the second key includes a table that is accessed by a hash function.

5. The method of claim 1, wherein at least one of the first key and the second key is implemented in an electronic circuit.

6. The method of claim 1, wherein at least one of the first key and the second key is implemented in the form of a computer program.

7. A data encryption system, comprising:
a programming unit in which a first key is provided;
a control unit in which a second key is provided; and
a data line coupled to the programming unit and the control unit for transmitting encrypted data.

8. The system of claim 7, wherein the first key and the second key are identical.

9. The system of claim 7, wherein the first key and the second key are not identical.

10. The system of claim 7, wherein the programming unit and the control unit each includes an electronic computing unit and a memory module that are linked together by a data bus.

11. A computer program for execution on a computing unit, the computer program comprising:
a program code arrangement for performing an encryption in accordance with a table and a hash function.

12. The computer program of claim 11, wherein the computing unit includes an electronic computing unit in a programming unit.

13. A computer program for execution on a company unit, the computer program comprising:
a program code arrangement for performing a decryption in accordance with a table and a hash function.

14. The computer program of claim 11, wherein the computing unit includes an electronic computing unit in a control unit.

15. A computer-readable medium, comprising:
a program code arrangement for performing an encryption in accordance with a table and a hash function.

16. A computer-readable medium, comprising:
a program code arrangement for performing a decryption in accordance with a table and a hash function.
